(19) United States
(12) Patent Application Publication
(10) Pub. No.: US 2024/0092642 A1
(43) Pub. Date: Mar. 21, 2024

(54) New production method of carbon (nano)-structures from pyrolysis oil

(71) Applicant: CarbonX B.V., Amsterdam (NL)

(72) Inventors: Rutger Alexander David van Raalten, Amsterdam (NL); Daniela Sordi, Amsterdam (NL); Robin Crepin, Amsterdam (NL)

(73) Assignee: CarbonX B.V., Amsterdam (NL)

(21) Appl. No.: 18/254,178

(22) PCT Filed: Nov. 23, 2021
(86) PCT No.: PCT/EP2021/082695

§ 371 Date: May 24, 2023

(30) Foreign Application Priority Data
Nov. 25, 2020 (EP) 20209899.2

(51) Int. Cl. C01B 32/15

(52) U.S. Cl. CPC C01B 32/15; C01P 2004/54; C01P 2006/16

(57) ABSTRACT

The invention pertains to a process for the production of crystalline carbon nanofibre networks from pyrolysis oil in a furnace black reactor 3 which contains a reaction zone 3b and a termination zone 3c, by injecting a thermodynamically stable pyrolysis oil-comprising micro-emulsion c, comprising metal catalyst nanoparticles, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon structure networks e, transferring these networks e to the termination zone 3c, and quenching or stopping the formation of crystalline carbon structure networks in the termination zone by spraying in water d.

### FIELD OF THE INVENTION

The invention is in the field of porous, chemically interconnected, carbon nanofibre-comprising carbon networks from sustainable resources, and directed towards new methods for manufacturing such sustainable structure networks and composites comprising such sustainable structures. The invention is particularly in the field of carbon black manufacturing.

### BACKGROUND TO THE INVENTION

The carbon black industry focuses on providing an allotrope of carbon mainly differing from graphite and amorphous carbon by its physical arrangement, for use in manufacturing rubber articles (e.g. tires), in polygraphy, electronics and cable coatings, in the production of varnishes and paints, including use applications in which reinforcing and/or pigmentary properties of carbon black are required. Various different processes or techniques are known in the art for producing carbon black. Carbon black is mainly produced by partial combustion processes, starting from a carbon containing gas such as methane or acetylene. This process is sometimes referred to as a furnace carbon black producing process, and it employs a furnace having a burner or combustion chamber followed by a reactor. The furnace process is typically characterized by low oxygen levels, low densities, high temperatures and short residence times.

As a first step of the furnace carbon black production process, hydrocarbons are atomized at typical temperatures from 1200 to 1900° C., as is described in Ullmanns Encyklopadie der technischen Chemie, Volume 14, page 637-640 (1977). To that end, a zone having a high energy density is produced by burning a fuel gas or a liquid fuel with oxygen or air, and the carbon black raw material is injected thereto. The carbon black feedstock is atomized in these hot combustion conditions; oxygen levels are on average supplied at a rate of two volumes of carbon black feedstock to about one volume of oxygen, in order to achieve the oxygen being completely consumed in the combustion process. The structure and/or the porosity of the carbon black end product may be influenced by the presence of alkali metal or alkaline earth metal ions during the carbon black formation, and such additives are therefore frequently added in the form of aqueous solutions, which are sprayed onto the carbon black raw material agglomerates. The reaction is terminated only by the injection of water (quenching) and the carbon black is collected at a temperature of about 200-250° C., and separated from the waste gas by means of conventional separators or filters. Because of its low bulk density, the resulting carbon black is then granulated, for instance carried out in a pelletizing machine with the addition of water to which small amounts of a pelletizing auxiliary may be added.

In chronological order, and by no means limiting the art on furnace carbon black technology, U.S. Pat. Nos. 2,672,402, 4,292,291, 4,636,375, WO2000/032701 and US 2004/0248731 provide a description of traditional or conventional carbon black production. Their contents are herewith incorporated by reference. Regarding the carbon black feedstock, worldwide approximately 17.5M ton per year of carbon black is produced using anthracene oil, coal tar oil and FCC slurry or pitch from steam crackers as the main feedstocks to produce carbon black. Assuming a 50% conversion, this translates into the fact that 35 M ton of crude oil/coal derived feedstock is required to supply the market every year. Replacing these feedstocks by a sustainable feedstock source could potentially save 150M ton of CO2 emissions.

US2011/0200518 describes a process for producing pyrolyzed carbon black (pCB) from rubber composites, such as tire rubber. However, the pyrolysis is applied to the tires in order to produce a char that ultimately leads to the carbon black; pyrolysis oil is not used as a carbon black feedstock. Okoye et al., Journal of Cleaner Production, 2020 (https://doi.org/10.1016/j.jclepro.2020.123336) reviews and discloses that tire pyrolysis oil could be used as a potential feedstock for carbon black (point 6, Spent tyre pyrolysis oil as a potential feedstock for carbon black). However, its assessment is based on lab-scale experiments, and thus issues arising from its industrial scale application such as yields and grades of the carbon black produced and the logistics of operating with pyrolysis oils are not assessed. For instance, it refers to the laboratory studies of Wójtowicz et al., Advanced Fuel Research, Inc, 2004 as showing that using the oil fraction of a spent tire pyrolysis process, carbon black could be obtained using a furnace reactor operated at 1100° C. and for a residence time of 5 and 20 seconds; and of Toth et al., Green Chemistry, 2018, 20, 3981-3992 (https://doi.org/10.1039/c8gc01539b) reporting the production of CB from a furnace reactor using pyrolysis bio-oil from a mixture of stem wood sawdust in a simulated furnace reactor operated at a temperature range of 1100-1700° C., with a residence time around 30 seconds. Nevertheless, Okoye concludes that there are currently no studies examining the absorptive or structural properties of carbon black from pyrolysis oil (point 6, last line). This together with fact that there is currently no commercial process which makes use of pyrolysis oil for carbon black manufacturing evidences a gap of knowledge in the carbon black manufacturing based on pyrolysis oil.

WO2013/170358 describes to produce carbon black with very low Polycyclic Aromatic Hydrocarbon (PAH) content from pyrolysis oil in a furnace reactor. However, it very generically claims to be able to produce any N-series carbon black from oil derived from waste tire pyrolysis without providing any specific process or product data to carry out the invention. In fact, it is generally accepted in the industry that using the described process to make carbon black from pyrolysis oil would lead to yields that are too low and of too low quality to be commercially viable, especially regarding the obtaining of the same range of grades that can be produced using a regular carbon black feedstock. Derived from carbon black based manufacturing, WO 2018/002137 describes a process for the production of crystalline carbon structure networks in a furnace black reactor using the carbon feedstock in the form of a thermodynamically stable micro-emulsion comprising metal catalyst nanoparticles. WO 2019/224396 relates to the use of porous, chemically interconnected, carbon-nanofibre-comprising carbon networks for reinforcing elastomers to be used in many areas of technology such as tyres, conveyor belts, hoses, etc. Pyrolysis oil is not specifically mentioned for a carbon source.

Using a different technology, EP3486212 describes a method for manufacturing crystalline carbon nanostructures and/or a network of crystalline carbon nanostructures. It involves bringing a bicontinuous micro-emulsion containing metal nanoparticles into contact with a substrate, wherein the metal nanoparticles and a gaseous carbon source are subjected to chemical vapor deposition.

Pyrolysis oil is a liquid blend of molecules derived from different sources, such as end-of-life tires, waste plastics or biomass. The exact composition of the pyrolysis oil depends heavily on both the source and the processing conditions. The large variation in composition between batches and the need of several upgrading steps to obtain high-quality oils (Zhang et al., Energy Conversion and Management, 2007, 48, 87-92 and Miandad et al., Process Safety and Environmental Protection, 2016, 102, 822-838) have limited the commercial use of pyrolysis oil to heat & power generation. There is significant variation in terms of sulphur and water levels depending on the source and processing conditions. The same accounts for the aromatic content, and these variations hinder the setup of an industrially controllable carbon black manufacturing running on pyrolysis oil for a carbon feedstock source.

There remains a direct need for updating the traditional carbon black manufacturing process from a sustainability perspective, wherein sustainability is understood as seeking to improve the efficiency with which natural resources are used to meet human needs for chemical products and services via the design, manufacture and use of efficient, effective, safe and more environmentally benign chemical products and processes (OECD definition). A pyrolysis refinery step makes pyrolysis not an attractive candidate for making carbon black manufacturing more sustainable, and if anything it adds costs to the process. The direct use of pyrolysis oil in a commercial process for carbon black manufacturing would thus represent a sustainability achievement.

### SUMMARY TO THE INVENTION

The inventors found that well-established reducing (pyrolysis) or oxidizing (combustion) carbon black manufacturing processes can be used to convert pyrolysis oil into a novel carbon filler composed of a network of porous, chemically interconnected, carbon nanofibre-comprising carbon structures having all kinds of advantageously improved electrical, mechanical and thermal properties, by introducing the concept of single-phase emulsification using thermodynamically stable micro-emulsions of the w/o, o/w or bicontinuous type, preferably w/o or bicontinuous type, most preferably bicontinuous type, with metal catalyst nanoparticles, and with the oil phase comprising or consisting of pyrolysis oil, to conventional (furnace) carbon black production. The advantage associated with single-phase emulsification applied in the context off the invention is not just in using abundantly present and economically attractive raw materials without the need for extensive processing, it also makes it possible to produce carbon black materials from recycled oils from pyrolysis processes, rendering it sustainable (circular), and which can be commercialized as sustainable as a technical feature of the product. It was also found that the process yields carbon networks with improved wettability properties.

The invention thus relates to a process for producing porous, chemically interconnected, carbon nanofibre-comprising carbon structure networks by providing a thermodynamically stable single-phase emulsion comprising pyrolysis oil, water and at least one surfactant, and also metal catalyst nanoparticles, and subjecting the emulsified pyrolysis oil to a carbon black manufacturing process, carbonizing said emulsified pyrolysis oil at increased temperatures above 600° C., preferably above 700° C., more preferably above 900° C., even more preferably above 1000° C., most preferably above 1100° C., preferably up to 3000° C., more preferably up to 2500° C., particularly up to 2000° C.

The above processes are industrial processes, characterized in that the reactor residence time of the single-phase emulsion (and thus the pyrolysis oil that is provided to the process in emulsion form) is less than 5 seconds, preferably less than 2 seconds, more preferably 1-1000 miliseconds, most preferably 10-500 ms.

In a related aspect, the invention pertains to the use of such a single-phase emulsion of emulsified pyrolysis oil for carbonizing the emulsion in a carbon black manufacture process, preferably a furnace carbon black manufacture process, thus obtaining sustainable porous, chemically interconnected, carbon nanofibre-comprising carbon structure networks. The emulsion is preferably sprayed and atomized into the reactor at the above-mentioned elevated temperatures.

In a preferred embodiment, pyrolysis oil is the predominant carbon feedstock source in the above process, preferably making up for at least 50%, more preferably 75-100% of all carbon feedstock provided to the process. In a most preferred embodiment, the pyrolysis oil is the only carbon feedstock source.

With the term ‘pyrolysis oil’ it is understood as any oil (directly) derived from the pyrolysis of different streams from chemical processes such as biomass (for instance wood, algae, rice, nuts shells), end-of-life tires or non-recyclable plastics, subjected to the process of the invention without further processing upfront. Pyrolysis oil does not refer to the char obtained from the pyrolysis of these raw materials. The sulphur content of the pyrolysis oil typically varies from 0.002% to 3% (according to ASTM D1619), the water content is typically between 1-40 wt %, oxygen atom content from 0.2% to 50 wt % and the carbon content is preferably at least 40 wt %. The aromaticity of the carbon source is irrelevant; the process of the invention works with either aliphatic, aromatic or combinations of the two carbon types. In view of foregoing, the pyrolysis oil as provided to the process is unrefined i.e. has not been subjected to refinery beforehand.

Throughout the text and claims, a ‘single-phase emulsion’ is a thermodynamically stable water-in-oil (w/o) or oil-in-water (o/w) micro-emulsion or a bicontinuous micro-emulsion comprising metal catalyst nanoparticles. Bicontinuous micro-emulsions comprising metal catalyst nanoparticles are most preferred.

The inventors acknowledged that there is a prejudice against the use of pyrolysis oil as a carbon black feedstock on commercial scale. Through the eyes of the skilled person, (unrefined) pyrolysis oil would not be a suitable feedstock for carbon black production for several reasons. Firstly, in a traditional carbon black manufacturing process the use of water should at least be minimized and preferably banned from the reaction sector to obtain proper yields and preferred spherical carbon black structures. This leads to a wide-spread reluctance of using any water during traditional carbon black manufacture, other than for quenching purposes in the closing stages. In a similar way, some pyrolysis oils may contain excessive amounts of sulphur or oxygen atoms to guarantee an appropriate carbon black structure formation, while other pyrolysis oils do not contain enough precursor (aromatic content) to form significant amounts of carbon black in an industrial scale reactor, because of the low residence times of industrial furnace black reactors, which do not provide enough time to form graphitic layers from non-ideal precursors. The combination of high water content, low aromatic, high oxygen atom and/or high sulphur content and need for high residence time make the use of (unrefined) pyrolysis oil for production of carbon black in a furnace reactor (which requires low residence times to produce the right quality of carbon structure) not suited on industrial scales, and this is what has held the skilled person back from switching to this sustainable feedstock.

The inventors found that amending the conventional carbon black manufacture by atomizing a stable single-phase emulsion with metal catalyst particles, makes it possible to work with pyrolysis oil without the need for a preceding refinery step. The inventors believe that the orientation and structuring of the surfactant molecules, pyrolysis oil phase and water phase together with the metal catalyst nanoparticles give rise to the network-forming process that is unique to the new material and to the process. The inventors found that it is key to provide the pyrolysis oil, in the form of a single-phase emulsion as described above, to the atomization process.

Metal catalyst nanoparticles are essential for the invention. The single-phase emulsions subjected to atomization and subsequent carbonization should comprise metal nanoparticles which act as catalyzers in forming these porous, chemically interconnected, carbon nanofibre-comprising carbon networks. An increasing concentration of metal catalyst nanoparticles further enhances yields. It is essential to use bicontinuous or water-in-oil (w/o) micro-emulsions, wherein the emulsions comprise metal catalyst nanoparticles, which emulsions comprise of a continuous oil/surfactant phase thus already forming a network structure, or an oil-in-water (o/w) micro-emulsion, wherein the emulsion comprises metal catalyst nanoparticles. Bicontinuous micro-emulsions are most preferred. The microstructures of the emulsions (either water-in-oil, oil-in-water, or bicontinuous) are thought to act as a precursor/blue-print for the final carbon structure network, of which the carbon-containing fractions (pyrolysis oil phase and surfactant) will form the fibers and junctions, whilst the water fraction helps orienting the pyrolysis oil/surfactant phase and network porosity. The presence of a metal catalyst promotes the carbonization of the carbon components into a fiber structure instead of the normally obtained spherical orientation. A blend of an immiscible pyrolysis oil and water phase will not yield these structures, i.e. without a metal catalyst in a thermodynamically stable matrix present. Once the emulsion is atomized at high temperatures the carbonization process instantly “freezes” the carbon fractions in its emulsion-structure in the presence of a metal catalyst, while the water evaporates, leaving a network of (nano)fibers.

By using the aforementioned emulsion with the active component, thus driving the process by catalysis (kinetic) and not thermodynamics, the inventors were able to produce the graphitic layers in millisecond timescales, which enables the use of the process in an industrial furnace black reactor scale. This is based on the inventors' understanding of carbon black formation on narrow crystallite and particle size distribution, crystallite alignment in one direction or filament formation. What is more, the catalyst enables the conversion of different feedstocks (aromatic and aliphatic), thus enabling the use of pyrolysis oil for the production of carbon black products with adequate technical properties.

Pyrolysis oil can be obtained from several waste streams such as biomass (wood, algae, rice, nuts shells, etc.), end-of-life tires or non-recyclable plastics, and thus the carbon filler production process according to this invention can be considered as recycling process, and even upcycling, for two reasons. Firstly, given that the pyrolysis oil is a low-end product, using it to produce a high-end carbon filler brings a lot of value to the source. Secondly, with the considerable improvement of properties that carbon filler brings to polymer such as mechanical reinforcement, control of the electrical conductivity (targets of ESD or EMI shielding ranges) and thermal conductivity, the properties of these recycled polymers (usually with poorer properties) combined with the carbon filler described by this invention can be comparable or better than the properties of virgin polymers and/or virgin polymers with carbon fillers made with crude oil derived feedstocks.

Furthermore, due to this invention the carbon filler production process becomes circular by upcycling of waste streams, further increasing the sustainability of the process, and thus also the product obtained by the process. For instance, considering tires as source for the pyrolysis oil, it means that tires containing carbon fillers are used as source to produce the same carbon fillers, thus reducing the carbon footprint of the final product. Furthermore, this carbon filler can be circularly produced on an industrial scale, making it the first upcycled carbon filler that is made from waste streams on a commercial scale. The fields of application for this circular carbon filler are diverse: rubbers (tires and technical rubber goods), thermoplastics, 3D printing, thermosets, coatings and inks, battery electrodes, energy storage materials or water purification membranes. Hence, the invention also pertains to the use of sustainable porous, chemically interconnected, carbon nanofiber comprising-carbon networks, particularly in increasing sustainability in rubbers (tires and technical rubber goods), thermoplastics, 3D printing, thermosets, coatings and inks, battery electrodes, energy storage materials or water purification membranes.

### BRIEF DESCRIPTION OF THE DRAWINGS

FIG. 1A is a schematic diagram of a continuous furnace carbon black producing process in accordance with the present invention which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas al from the combustion zone 3a into the reaction zone 3b, spraying (atomizing) a single-phase emulsion c in the reaction zone 3b containing the hot waste gas, carbonizing said emulsion at increased temperature, and quenching or stopping the reaction in the termination zone 3c by spraying in water d, to obtain porous, chemically interconnected, carbon nanofibre-comprising carbon networks e according to the invention;

### CLAUSES OF THE INVENTION

1. A process for the production of crystalline carbon structure networks from pyrolysis oil in a reactor 3 which contains a reaction zone 3b and a termination zone 3c, by injecting a single-phase emulsion c, being a micro-emulsion comprising pyrolysis oil and metal catalyst nanoparticles according to the invention into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon structure networks e, transferring these networks e to the termination zone 3c, and quenching or stopping the formation of crystalline carbon structure networks in the termination zone by spraying in water d.
2. The process according to clause 1, said reactor being a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying a micro-emulsion comprising pyrolysis oil and metal catalyst nanoparticles c, in the reaction zone 3b containing the hot waste gas, carbonizing said micro-emulsion at a temperature of above 600° C., preferably above 700° C., more preferably above 900° C., even more preferably above 1000° C., more preferably above 1100° C., preferably up to 3000° C., more preferably up to 2500° C., most preferably up to 2000° C., and quenching or stopping the reaction in the termination zone 3c by spraying in water d, to yield crystalline carbon structure networks e.
3. The process according to any one of the preceding clauses, wherein the pyrolysis oil phase in the emulsion has a carbon content at least 40 wt %, and added water content up to 50 wt %, a sulphur content up to 4 wt % and up to 50 wt % of oxygen atom content, based on the total weight of the pyrolysis oil.
4. The process according to any one of the preceding clauses, said emulsion comprising at least 1 mM metal catalyst nanoparticles, preferably having an average particle size between 1 and 100 nm.
5. The process according to any one of the preceding clauses, wherein at least 50 wt %, preferably all of the carbon feedstock from which the networks are made is provided as pyrolysis oil in the single-phase emulsion.
6. The process according to any one of the preceding clauses, wherein the reactor residence time of the pyrolysis oil that is provided in the single-phase emulsion c is less than 5 seconds, preferably less than 2 seconds, more preferably 1-1000 milliseconds, most preferably 10-500 milliseconds.
7. The process according to any one of the preceding clauses, wherein the pyrolysis oil provided to reactor 3 has a sulphur content between 0.5 and 4.0 wt %, based on the weight of the pyrolysis oil.
8. The process according to any one of the preceding clauses, wherein the pyrolysis oil provided to reactor 3 has an oxygen atom content between 10 and 50 wt % based on the weight of the pyrolysis oil.
9. A sustainable porous carbon network material which comprises chemically interconnected carbon-nanofibres obtainable by the process according to any one of the preceding clauses, wherein the pores in the network have an intraparticle pore diameter size of 5-150 nm using Mercury Intrusion Porosimetry according to ASTM D4404-10, wherein at least 20 wt % of the carbon in the carbon networks is in crystalline form, and the carbon nanofibers have an average aspect ratio of fibre length-to-thickness of at least 2, wherein the pH of the carbon network obtained is at most 8.5, preferably between 4 and 8.5, most preferably between 5.5 and 7.5, and wherein the carbon is provided by pyrolysis oil.
10. Use of an emulsified pyrolysis oil in a carbon black manufacture process, preferably a furnace carbon black manufacture process, for producing sustainable crystalline carbon structure networks.
11. A substainable product comprising the sustainable porous carbon networks according to clause 9.

### DETAILED DESCRIPTION

The invention pertains to sustainable porous, chemically interconnected, carbon nanofibre-comprising carbon networks which are preferably obtainable by the process for the production of porous, chemically interconnected, carbon nanofibre-comprising carbon networks in a reactor 3, preferably a furnace black reactor, which contains a reaction zone 3b and a termination zone 3c, by injecting a water-in-oil, oil-in-water or bicontinuous micro-emulsion c comprising metal catalyst nanoparticles and pyrolysis oil, into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce sustainable porous, chemically interconnected, carbon nanofibre-comprising carbon networks e, transferring these networks e to the termination zone 3c, and quenching or stopping the formation of porous, chemically interconnected, carbon nanofibre-comprising carbon networks in the termination zone by spraying in water d.

In a more preferred embodiment, the networks are obtainable by the above process, said reactor being a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas al from the combustion zone 3a into the reaction zone 3b, spraying a water-in-oil, oil-in-water or bicontinuous micro-emulsion c comprising metal catalyst nanoparticles and pyrolysis oil, in the reaction zone 3b containing the hot waste gas, carbonizing said emulsion at a temperature of above 600° C., preferably above 700° C., more preferably above 900° C., even more preferably above 1000° C., more preferably above 1100° C., preferably up to 3000° C., more preferably up to 2500° C., most preferably up to 2000° C., and quenching or stopping the reaction in the termination zone 3c by spraying in water d, to yield porous, chemically interconnected, carbon nanofibre-comprising carbon networks e.

The above processes are industrial processes. Typical production rates of industrial reactors are 1-tonnes of sustainable porous, chemically interconnected, carbon nanofibre-comprising carbon networks per hour. Typical residence times in the reactor 3 between 1 and 1000 ms.

The networks are preferably obtainable by the above process wherein further processing details are provided in the section headed “Process for obtaining carbon nanofibre-comprising carbon networks” here below, and in the accompanying FIGURES.

Throughout the description and claims, the terms ‘carbon structure networks’, ‘carbon networks’, ‘carbon nanofibre-comprising carbon networks’ and ‘carbon nanofiber networks’ are used interchangeably. Details of the networks formed from carbon nanofibers and the manufacturing details are given below.

### Process for Obtaining Carbon Nanofibre-Comprising Carbon Networks

The process for obtaining the sustainable porous, chemically interconnected, carbon nanofibre-comprising carbon networks can be described best as a modified carbon black manufacturing process wherein pyrolysis oil is provided to the reaction zone of a carbon black reactor as part of a single-phase emulsion, being a thermodynamically stable micro-emulsion, comprising metal catalyst nanoparticles. The emulsion is preferably provided to the reaction zone by spraying, thus atomizing the emulsion to droplets. The modified carbon black manufacturing process is advantageously carried out as a continuous process.

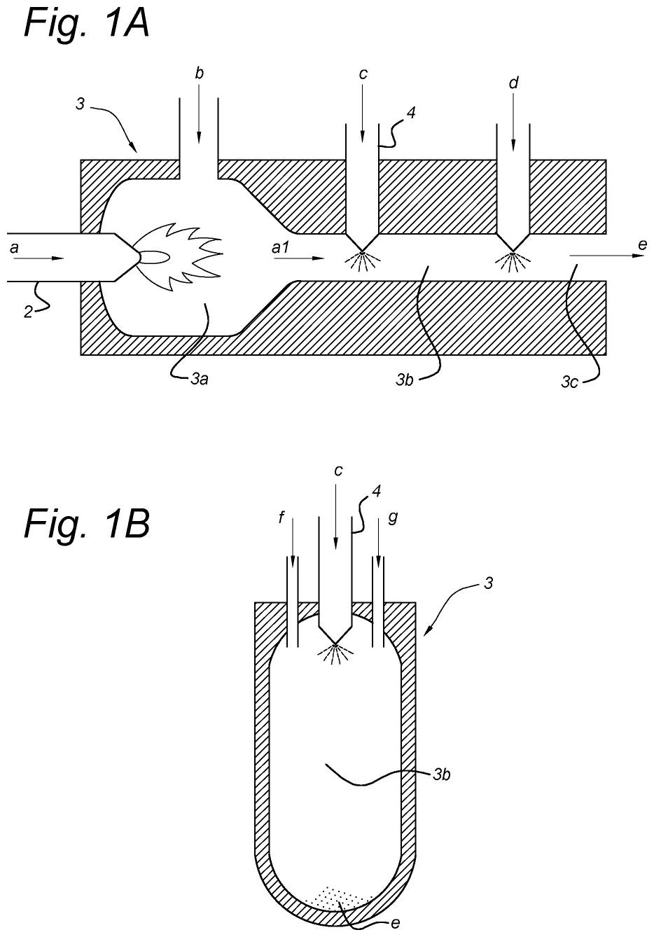

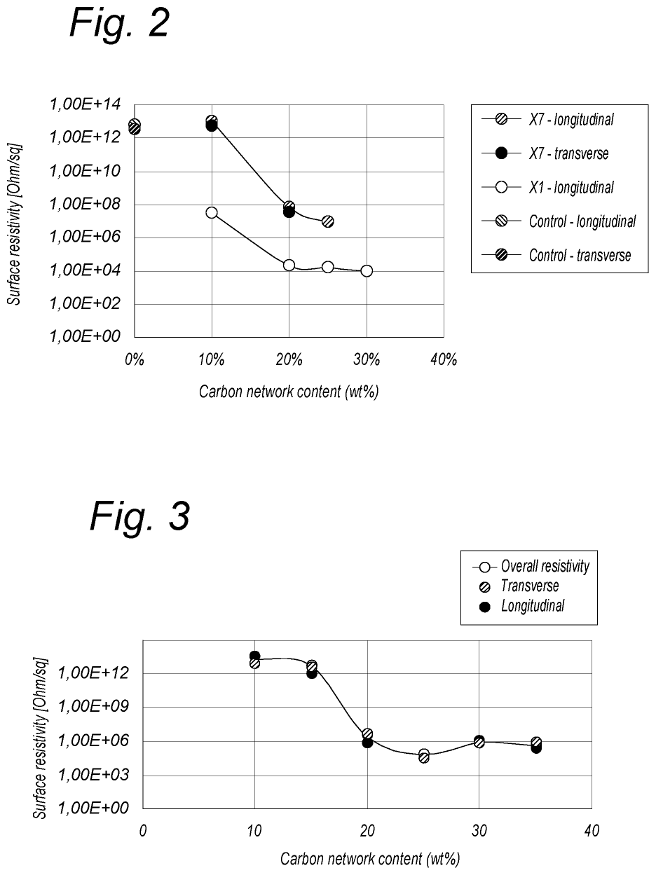

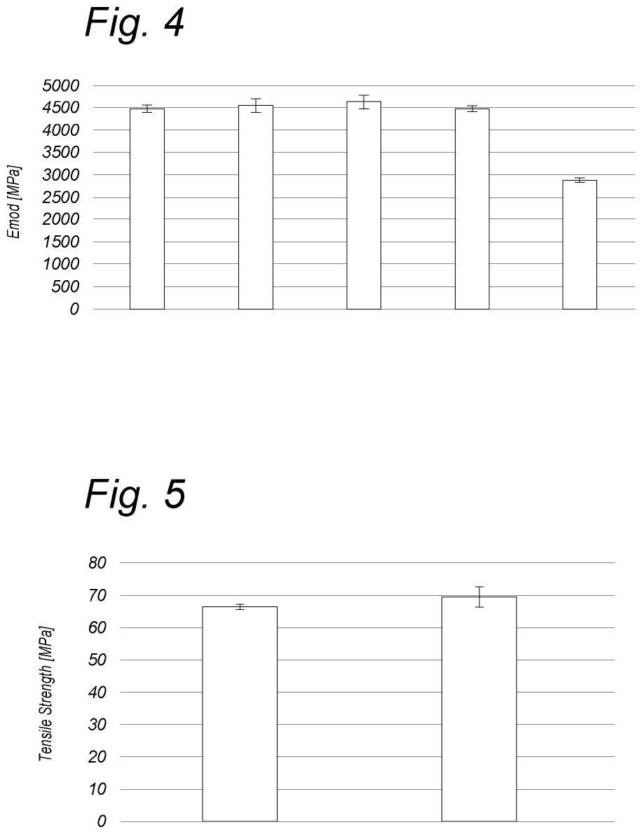

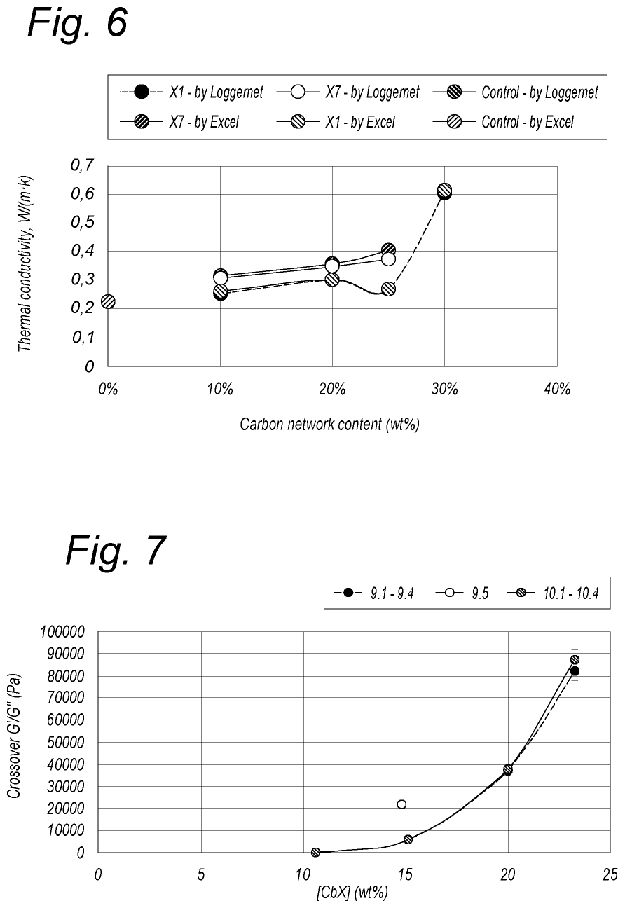

In one aspect, the invention pertains to a process for the production of the carbon structure networks from pyrolysis oil in a reactor 3 which contains a reaction zone 3b and a termination zone 3c, by injecting a single-phase emulsion c, being a micro-emulsion comprising pyrolysis oil and metal catalyst nanoparticles according to the invention into the reaction zone 3b which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce porous, chemically interconnected, carbon nanofibre-comprising carbon networks e, transferring these networks e to the termination zone 3c, and quenching or stopping the formation of porous, chemically interconnected, carbon nanofibre-comprising carbon networks in the termination zone by spraying in water d. The single-phase emulsion is preferably sprayed into the reaction zone. Reference is made to FIG. 1.

In a preferred embodiment, the invention pertains to a process for the production of the porous, chemically interconnected, carbon nanofibre-comprising carbon networks according to the invention in a furnace carbon black reactor 3 which contains, along the axis of the reactor 3, a combustion zone 3a, a reaction zone 3b and a termination zone 3c, by producing a stream of hot waste gas a1 in the combustion zone by burning a fuel a in an oxygen-containing gas b and passing the waste gas a1 from the combustion zone 3a into the reaction zone 3b, spraying (atomizing) a single-phase emulsion c comprising pyrolysis oil and metal catalyst nanoparticles according to the invention, preferably a micro-emulsion comprising pyrolysis oil and metal catalyst nanoparticles, in the reaction zone 3b containing the hot waste gas, carbonizing said emulsion at increased temperatures (at a temperature of above 600° C., preferably above 700° C., more preferably above 900° C., even more preferably above 1000° C., more preferably above 1100° C., preferably up to 3000° C., more preferably up to 2500° C., most preferably up to 2000° C.), and quenching or stopping the reaction (i.e. the formation of porous, chemically interconnected, carbon nanofibre-comprising carbon networks e) in the termination zone 3c by spraying in water d. The reaction zone 3b comprises at least one inlet (preferably a nozzle) for introducing the emulsion, preferably by atomization. Reference is made to FIG. 1. Residence times for the emulsion in the reaction zone of the furnace carbon black reactor can be relatively short, preferably ranging from 1-1000 ms, more preferably 10-500 ms. Longer residence times may have an effect on the properties of the carbon networks. An example may be the size of crystallites which is higher when longer residence times are used.

The pyrolysis oil phase can be aromatic and/or aliphatic. The single-phase emulsion with metal catalyst nanoparticles enables the skilled person to use a variety of pyrolysis sources without refinery steps. Good examples are oils taken from pyrolysis of biomass, plastic or end-of-life tires. The carbon content of this pyrolysis oil should be at least 40 wt %, the water content can be between 1-40 wt %, sulphur content up to 4 wt % and 0.2 to 50% oxygen atom content. In one embodiment, the oxygen atom content is preferably between 10 and 50%.

In conventional carbon black processing, the pyrolysis oil preferably has low sulfur content, as sulfur adversely affects the product quality, leads to lower yield and corrodes the equipment. It is preferred that the sulfur content of the pyrolysis oil according to ASTM D1619 is less than 8.0 wt %, preferably below 4.0 wt % more preferably less than 2.0 wt %. In one embodiment, the sulphur content of the pyrolysis oil according to ASTM D1619 is between 0.5 and 8 wt %, preferably between 0.5 and 4.0 wt %; for the process of the invention there is no necessity to work with sulphur levels for refined pyrolysis oil levels below 0.002 wt %.

The feedstock used to produce our network of porous, chemically interconnected, carbon nanofibre-comprising carbon networks is provided in the form of the oil component in an emulsion that comprises at least a pyrolysis oil, a surfactant and water. The oil content of the emulsion is at least 50 wt %, the added water can be between 1-50 wt % and the surfactant content varies as a function of the oil and the water content. In a preferred embodiment, all carbon feedstock is provided by one or more pyrolysis oils, from one or different pyrolysis oil sources. In other words, the oil in the emulsion preferably consists of pyrolysis oil. The water content of the pyrolysis oil is also a parameter to be taken into account when formulating the emulsion. This emulsion is a single-phase emulsion in the sense that no physical separation can be seen with the naked eye. When examined under the microscope, separate oil and water phases can be distinguished. More precisely a water-in-oil, oil-in-water or a bi-continuous micro-emulsion is observed. The emulsion is thermodynamically stable, meaning that no external force is required to keep constant for at least 1 minute, and preferably the pH of the water phase is kept within a window of ±1 pH unit and the viscosity of the emulsion shows variation only within a window of ±20%.

The water phase of the emulsion contains an active component, which has a catalytic function during the formation of the porous, chemically interconnected, carbon nanofibre-comprising carbon networks. The active component is made up out of metal particles or metal complexes, with a size ranging from 1-100 nm. The metal can be a noble metal (Au, Ag, Pd, Pt etc.) a transition metal (Fe, Ru etc.) or other metals like Ti or Cu. Suitable metal complexes are but are not limited to platinum precursors such as H2PtCl6; ruthenium precursors such as Ru(NO)(NO3)3; or (iii) palladium precursors such as Pd(NO3)2, or nickel precursors such as NiCl2. The active metal concentration in the water phase should be >1 mM.

The pyrolysis oil emulsion is a “single-phase emulsion” which is understood to mean that the pyrolysis oil phase and the water phase optically appear as one miscible mixture showing no physical separation of pyrolysis oil, water or surfactant to the naked eye. The single-phase emulsion is a micro-emulsion. The process by which an emulsion completely breaks (coalescence), i.e. the system separates into bulk oil and water phases, is generally considered to be controlled by four different droplet loss mechanisms, i.e., Brownian flocculation, creaming, sedimentation flocculation and disproportionation.

Provided that a stable, single-phase emulsion is obtained, the amounts of added water and pyrolysis oil are not regarded limiting, but it is noted that reduced amounts of water (and increased amounts of pyrolysis oil) improve yields. The added water content (i.e. not including the water content of the pyroslysis oil) is typically between 5 and 50 wt % of the emulsion, preferably 10-40 wt %, even more preferably up to 30 wt %, more preferably 10-20 wt % of the emulsion. The added water levels should take into account how much water is already provided with the pyrolysis oil. While higher amounts of water can be considered, it will be at the cost of yield. Without wishing to be bound by any theory, the inventors believe that the water phase attributes to the shape and morphology of the networks thus obtained.

There is typically 5-30 wt % surfactant present, preferably 10-20 wt %, calculated on the weight of the emulsion provided in step a). The surfactant can be a non-ionic surfactant with a hydrophilic-lipophilic balance (HLB) value of at least 7, preferably an HLB value of 10. Ionic surfactants such as (but not limited to) dioctyl sodium sulfosuccinate (AOT), stabilizing water in oil mixtures can also be used. The choice of surfactant(s) is not regarded a limiting factor, provided that the combination of the pyrolysis oil, water and surfactant(s) results in a stable micro-emulsion as defined here above. As further guidance to the skilled person, it is noted that the surfactant can be selected on the basis of the hydrophobicity or hydrophilicity of the system, i.e. the hydrophilic-lipophilic balance (HLB). The HLB of a surfactant is a measure of the degree to which it is hydrophilic or lipophilic, determined by calculating values for the different regions of the molecule, according to the Griffin or Davies method. The appropriate HLB value depends on the type of pyrolysis oil and the amount of pyrolysis oil and water in the emulsion, and can be readily determined by the skilled person on the basis of the requirements of retaining a thermodynamically stable, single phase emulsion as defined above. It is found that an emulsion comprising more than 50 wt % pyrolysis oil, preferably having less than 30 wt % water phase, would be stabilized best with a surfactant having an HLB value above 7, preferably above 8, more preferably above 9, most preferably above 10. On the other hand, an emulsion with at most 50 wt % pyrolysis oil would be stabilized best with a surfactant having an HLB value below 12, preferably below 11, more preferably below 10, most preferably below 9, particularly below 8.

The surfactant is preferably selected to be compatible with the pyrolysis oil phase. In case the pyrolysis oil has a high BMCI, a surfactant with high aromaticity is preferred, while a pyrolysis oil with low BMCI, such as characterized by BMCI <15, would be stabilized best using aliphatic surfactants. The surfactant(s) can be cationic, anionic or non-ionic, or a mixture thereof. One or more non-ionic surfactants are preferred, in order to increase the yields since no residual ions will be left in the final product. In order to obtain a clean tail gas stream, the surfactant structure is preferably low in sulfur and nitrogen, preferably free from sulfur and nitrogen. Non-limiting examples of typical non-ionic surfactants which can be used to obtain stable emulsions are commercially available series of tween, span, Hypermer, Pluronic, Emulan, Neodol, Triton X and Tergitol.

In the context of the invention, a micro-emulsion is a dispersion made of water, pyrolysis oil and surfactant(s) that is a single optically isotropic and thermodynamically stable liquid with dispersed domain diameter varying approximately from 1 to 500 nm, preferably 1 to 100 nm, usually 10 to 50 nm. In a micro-emulsion the domains of the dispersed phase are either globular (i.e. droplets) or interconnected (to give a bicontinuous micro-emulsion). In a preferred embodiment, the surfactant tails form a continuous network in the oil-phase of a water-in-oil (w/o) or oil-in-water emulsion or bicontinuous micro-emulsion. The water domains should contain a metal catalyst, preferably having an average particle size between 1 nm and 100 nm.

The single-phase emulsion, i.e. a w/o, o/w or bicontinuous micro-emulsion, preferably a bicontinuous micro-emulsion, further comprises metal catalyst nanoparticles preferably having an average particle size between 1 and 100 nm. The skilled person will find ample guidance in the field of carbon nanotubes (CNTs) to produce and use these kinds of nanoparticles. These metal nanoparticles are found to improve network formation in terms of both rates and yields, and reproducibility. Methods for manufacturing suitable metal nanoparticles are found in Vinciguerra et al. “Growth mechanisms in chemical vapour deposited carbon nanotubes” Nanotechnology (2003) 14, 655; Perez-Cabero et al. “Growing mechanism of CNTs: a kinetic approach” J. Catal. (2004) 224, 197-205; Gavillet et al. “Microscopic mechanisms for the catalyst assisted growth of single-wall carbon nanotubes” Carbon. (2002) 40, 1649-1663 and Amelinckx et al. “A formation mechanism for catalytically grown helix-shaped graphite nanotubes” Science (1994) 265, 635-639, their contents about manufacturing metal nanoparticles herein incorporated by reference. In one embodiment, the water:surfactant weight ratio is between 2:1 and 1:5, preferably between 1:1 and 1:4.

The metal catalyst nanoparticles are used in a pyrolysis oil-comprising bicontinuous, w/o or o/w microemulsion. In one embodiment, a bicontinuous micro-emulsion is most preferred. Advantageously, the uniformity of the metal particles is controlled in said (bicontinuous) micro-emulsion by mixing a first (bicontinuous) micro-emulsion in which the aqueous phase contains a metal complex salt capable of being reduced to the ultimate metal particles, and a second (bicontinuous) micro-emulsion in which the aqueous phase contains a reductor capable of reducing said metal complex salt; upon mixing the metal complex is reduced, thus forming metal particles. The controlled (bicontinuous) emulsion environment stabilizes the particles against sintering or Ostwald ripening. Size, concentrations and durability of the catalyst particles are readily controlled. It is considered routine experimentation to tune the average metal particle size within the above range, for instance by amending the molar ratio of metal precursor vs. the reducing agent. An increase in the relative amount of reducing agent yields smaller particles. The metal particles thus obtained are monodisperse, deviations from the average particle size are preferably within 10%, more preferably within 5%. Also, the present technology provides no restraint on the actual metal precursor, provided it can be reduced.

Non-limiting examples of nanoparticles included in the carbon nanofibre-comprising carbon networks are the noble metals (Pt, Pd, Au, Ag), iron-family elements (Fe, Co and Ni), Ru, and Cu. Suitable metal complexes are but are not limited to (i) platinum precursors such as H2PtCl6; H2PtC16·xH2O; K2PtCl4; K2PtCl4·xH2O; Pt(NH3)4(NO3)2; Pt(C5H7O2)2, (ii) ruthenium precursors such as Ru(NO)(NO3)3; Ru(dip)3Cl2 [dip=4,7-diphenyl-1,10-fenanthroline]; RuCl3, or (iii) palladium precursors such as Pd(NO3)2, or (iv) nickel precursors such as NiCl2 or NiCl2·xH2O; Ni(NO3)2; Ni(NO3)2·xH2O; Ni(CH3COO)2; Ni(CH3COO)2·xH2O; Ni(AOT)2 [AOT=bis(2-ethylhexyl)sulphosuccinate], wherein x may be any integer chosen from 1, 2, 3, 4, 5, 6, 7, 8, 9 or 10 and typically is 6, 7 or 8. Non-limiting suitable reducing agents are hydrogen gas, sodium boron hydride, sodium bisulphate, hydrazine or hydrazine hydrate, ethylene glycol, methanol and ethanol. Also suited are citric acid and dodecylamine. The type of metal precursor is not an essential part of the invention.

The metal of the particles of the (bicontinuous) micro-emulsion is preferably selected from the group consisting of Pt, Pd, Au, Ag, Fe, Co, Ni, Ru and Cu, and mixtures thereof, in order to control the morphology of the carbon structure networks ultimately formed. The metal nanoparticles end up embedded inside these structures where the metal particles are physically attached to the structures. While there is no minimum concentration of metal particles at which these networks are formed—in fact networks are formed using the modified carbon black manufacturing process according to the invention—it was found that the yields increase with the metal particle concentrations. In a preferred embodiment, the active metal concentration is at least 1 mM, preferably at least 5 mM, preferably at least 10 mM, more preferably at least 15 mM, more preferably at least 20 mM, particularly at least 25 mM, most preferably up to 3500 mM, preferably up to 3000 mM. In one embodiment, the metal nanoparticles comprise up to 250 mM. These are concentrations of the catalyst relative to the amount of the aqueous phase of the (bicontinuous) micro-emulsion.

Atomization of the pyrolysis oil-comprising single-phase emulsion is preferably realized by spraying, using a nozzle-system 4, which allows the emulsion droplets to come in contact with the hot waste gas al in the reaction zone 3b, resulting in traditional carbonization, network formation and subsequent agglomeration, to produce porous, chemically interconnected, carbon nanofibre-comprising carbon networks e according to the invention. The injection step preferably involves increased temperatures above 600° C., preferably between 700 and 3000° C., more preferably between 900 and 2500° C., more preferably between 1100 and 2000° C.

Sustainable Porous Carbon Networks

The networks of the invention can be characterized as below.

The terms ‘sustainable porous carbon networks’ and ‘sustainable porous carbon network material are used interchangeably.

First and foremost, these networks are circular, meaning that the carbon is produced from a waste product (i.e. end-of-life tires, non-recyclable plastics or biomass waste). By converting this waste product into a useful carbon product up to 150M ton annually of CO2 can be saved. This does not include any benefits that the carbon product can bring when used in composites with elastomers or plastics. The circular or sustainable carbon product can be used to decrease the rolling resistance and/or abrasion resistance when used in tires, or boost the mechanical and electrical properties of recycled plastics; paving the way for truly sustainable high performance plastics and tires. At end of life the product can be fully recycled or serve as pyrolysis feedstock again, closing the loop. In this context, the terms ‘sustainable’ and ‘circular’ in the context of the invention are used interchangeably, and this terminology has a commercial as well as a technical meaning that goes beyond its manufacturing method. The product which is obtained from unrefined pyrolysis oil can be recognized as such, and can also be described as a product with a reduced carbon footprint.

In the context of the present invention, sustainability is preferably understood as seeking to improve the efficiency with which natural resources are used to meet human needs for chemical products and services via the design, manufacture and use of efficient, effective, safe and more environmentally benign chemical products and processes (OECD definition). A pyrolysis refinery step makes pyrolysis not an attractive candidate for making carbon black manufacturing more sustainable, and if anything it adds costs to the process. The direct use of pyrolysis oil in a commercial process for carbon black manufacturing would thus represent a sustainability achievement. The product which is the result of such processing of unrefined recycled pyrolysis is appreciated by skilled artisans and consumers being a sustainable product (i.e. the carbon network product is made from unrefined pyrolysis oil).

Compared to carbon from crude oil, carbon produced from pyrolysis oil has a lower pH, and a significant amount of polar groups such as carboxyl, hydroxyl and epoxy at the surface of these networks. These groups increases the affinity of the network structures in polar polymers (i.d. epoxy resins, polyamides and polyesters, SSBR functionalized for silica) and acidic reactive molecules (maleic anhydride grafted polypropylene of polyethylene, silanes and amino-silanes). In particular, carbon produced from pyrolysis oil has pH values of at most 7.5. Without being bound to theory this can result in a better interaction with the matrix, thus deriving into a product with enhanced characteristics, such as improving the interaction of the filler with the matrix. The pH of the final product is preferably between 4 and 7.5, most preferably between 5.5 and 7.5, more preferably 5.5-7.3, most preferably 5.5-7.0.

The skilled person will understand that a porous network refers to a 3-dimensional structure that allows fluids or gasses to pass through. A porous network may also be denoted as a porous medium or a porous material. The pore volume of the porous carbon networks according to the invention is 0.1-1.5 cm³/g, preferably 0.2-1.5 cm³/g, more preferably 0.3-1.3 cm³/g and most preferably 0.4-1.5 cm³/g as measured using the Brunauer, Emmett, and Teller (BET) method (ASTM D6556-09).

The carbon-nanofibre-comprising carbon networks may have an intraparticle pore diameter size as measured using Mercury Intrusion Porosimetry (ASTM D4404-10) of 5-150 nm, preferably 10-120 nm, and most preferably of 10-100 nm.

The carbon-nanofibre-comprising carbon networks may have an intraparticle volume as measured using Mercury Intrusion Porosimetry (ASTM D4404-10) of 0.10-1.1 cm³/g, preferably 0.51-1.0 cm³/g, and most preferably of 0.59-0.91 cm³/g.

The porous carbon network according to the invention (or a porous carbon network particle of the invention) can be seen as a big molecule, wherein the carbon atoms inherently are covalently interconnected. It is hereby understood that a porous carbon network particle is a particle with chemically interconnected (i.e. covalently bonded) fibers having intraparticle porosity, as opposed to interparticle porosity which refers to a porous network created by multiple molecules or particles and wherein the pores are formed by the space between physically aggregated particles or molecules. In the context of the current invention, intraparticle porosity may also be denoted as intramolecular porosity as the carbon network particle according to the invention can be seen as a big molecule, wherein the pores are embedded. Hence intraparticle porosity and intramolecular porosity have the same meaning in the current text and may be used interchangeable to describe the porous networks of the invention. Compare with traditional carbon black which have no intraparticle porous structure within the carbon black particle, but aggregates of carbon black particles may have interparticle porosity properties. While interparticle/intermolecular is space between physical aggregated particles (networks), intraparticle/intramolecular is space within the network itself.

Without being bound to a theory, it is believed that the benefit of having a network with intraparticle porosity over a network with interparticle porosity is that the first are more robust and more resilient against crushing and breaking when force is applied. Intraparticle porosity refers to pores existing inside a (nano)particle. Interparticle porosity refers to pores existing as an effect of stacking individual particles The interparticle pores are weaker due to the particle-particle interface and tend to collapse. Intraparticle pores are strong due to the covalently bonded structure surrounding them and can withstand high forces and pressures without collapsing.

As addressed here above, known reinforcing agents, such as carbon black, consist of aggregates or agglomerates of spherical particles that may form a 3-dimensional structure, but without any covalent connection between the individual particles (not ‘chemically interconnected’), thus having interparticle porosity. Summarizing, intraparticle porosity refers to the situation wherein the carbon atoms surrounding the pores are covalently connected, wherein interparticle porosity refers to pores residing between particles which are physically aggregated, agglomerated, or the like.

As the network of the invention can be seen as one big molecule, there is no need to fuse particles or parts of the network together. Hence it is preferred that the porous network of chemically interconnected, carbon-nanofibres are non-fused, intraparticle porous, chemically interconnected, carbon-nanofibre-comprising carbon networks, having intraparticle porosity. In a preferred embodiment, the intraparticle pore volume may be characterized as described further below, e.g. in terms of Mercury Intrusion Porosimetry (ASTM D4404-10) or Brunauer, Emmett and Teller (BET) method (ISO 9277:10).

The skilled person will readily understand that the term chemically interconnected in porous, chemically interconnected, carbon-nanofibre-comprising carbon networks implies that the carbon-nanofibres are interconnected to other carbon-nanofibres by chemical bonds. It is also understood that a chemical bond is a synonym for a molecular or a covalent bond. Typically those places where the carbon-nanofibres are connected are denoted as junctions or junctions of fibres, which may thus be conveniently addressed as ‘covalent junctions’ These terms are used interchangeable in this text. In the carbon networks according to the invention, the junctions are formed by covalently connected carbon atoms. It furthermore follows that the length of a fibre is defined as the distance between junctions which are connected by fibrous carbon material.

At least part of the fibres in the carbon-nanofibre-comprising networks of the invention are crystalline carbon-nanofibres. Preferably at least 20 wt. % of the carbon in the carbon networks in the invention is crystalline, more preferably at least 40 wt. %, even more preferably at least 60 wt. %, even more preferably at least 80 wt. % and most preferably at least 90 wt. %. Alternatively, the amount of crystalline carbon is 20-90 wt. %, more preferably 30-70 wt. %, and more preferably 40-50 wt. % compared to the total carbon in the carbon networks of the invention. Here crystalline has its usual meaning and refers to a degree of structural order in a material. In other words, the carbon atoms in the nanofibres are to some extent arranged in a regular, periodic manner. The areas or volumes which are crystalline can be denoted as crystallites. A carbon crystallite is hence an individual carbon crystal. A measure for the size of the carbon crystallites is the stacking height of graphitic layers. Standard ASTM grades of carbon black have a stacking height of the graphitic layers within these crystallites ranging from 11-13 Å (angstroms). The carbon-nanofibre-comprising carbon networks of the invention have a stacking height of at least 15 Å (angstroms), preferably at least 16 Å, more preferably at least 17 Å, even more preferably at least 18 Å, even more preferably at least 19 Å and still more preferably at least 20 Å. If needed the carbon networks with crystallites as large as 100 Å (angstroms) can be produced. Hence the carbon networks of the invention have a stacking height of up to 100 Å (angstroms), more preferably of up to 80 Å, even more preferably of up to 60 Å, even more preferably of up to 40 Å, still more preferably of up to 30 Å. It is therefore understood that the stacking height of graphitic layers within crystallites in the carbon networks of the invention is 15-90 Å (angstroms), more preferably 16-70 Å, even more preferably 17-50 Å, still more preferably 18-30 Å and most preferably 19-25 Å.

The porous, chemically interconnected, carbon-nanofibre-comprising carbon networks may be defined as having chemically interconnected carbon-nanofibres, wherein carbon-nanofibres are interconnected via junction parts, wherein several (typically 3 or more, preferably at least 10 or more) nanofibres are covalently joined. Said carbon-nanofibres are those parts of the network between junctions. The fibres typically are elongated bodies which are solid (i.e. non-hollow), preferably having an average diameter or thickness of 1-500 nm, preferably of 5-350 nm, more preferably up to 100 nm, in one embodiment 50-100 nm, compared to the average particle size of 10-400 nm for carbon black particles. In one embodiment, the average fibre length (i.e. the average distance between two junctions) is preferably in the range of 30-10,000 nm, more preferably 50-5,000 nm, more preferably 100-5,000 nm, more preferably at least 200-5,000 nm, as for instance can be determined using SEM.

The nanofibres or structures may preferably be described in terms of an average aspect ratio of fibre length-to-thickness of at least 2, preferably at least 3, more preferably at least 4, and most preferably at least 5, preferably at most below 50; in sharp contrast with the amorphous (physically associated) aggregates formed from spherical particles obtained through conventional carbon black manufacturing.

The carbon-nanofibre structures may be defined as carbon networks formed by chemically interconnected carbon-nanofibres. Said carbon networks have a 3-dimensional configuration wherein there is an opening between the carbon-nanofibres that is accessible to a continuous phase, which may be a liquid—such as a solvent or an aqueous phase —, a gas or any other phase. Said carbon networks are at least 0.5 μm in diameter, preferably at least 1 μm in diameter, preferably at least 5 μm in diameter, more preferably at least 10 μm in diameter, even more preferably at least 20 μm in diameter and most preferably 25 μm in all dimensions. Alternatively said carbon networks are at least 1 μm in diameter in 2 dimensions and at least 5 μm in diameter, preferably at least 10 μm in diameter, more preferably a least 20 μm in diameter and most preferably at least 25 μm in diameter in the other dimension. Here, and also throughout this text, the term dimension is used in its normal manner and refers to a spatial dimension. There are 3 spatial dimensions which are orthogonal to each other and which define space in its normal physical meaning. It is furthermore possible that said carbon networks are at least 10 μm in diameter in 2 dimensions and at least 15 μm in diameter, preferably at least 20 μm in diameter, more preferably a least 25 μm in diameter, more preferably at least 30 μm in diameter and most preferably at least 50 μm in diameter in the other dimension.

The carbon-nanofibre-comprising carbon networks may have a volume-based aggregate size as measured using laser diffraction (ISO 13320) or dynamic light scattering analysis of 0.1-100 μm, preferably 1-50 μm, more preferably 4-40 μm, more preferably of 5-35 μm, more preferably of 6-30 μm, more preferably of 7-25 μm and most preferably of 8-20 μm.

The surface area of the carbon-nanofibre-comprising carbon networks as measured according to the Brunauer, Emmett and Teller (BET) method (ISO 9277:10) is preferably in the range of 40-120 m²/g, more preferably 45-110 m²/g, even more preferably 50-100 m²/g and most preferably 50-90 m²/g.

The porous, chemically interconnected, carbon-nanofibre-comprising carbon networks may also comprise carbon black particles built in as part of the network. These particles are profoundly found at the junctions between carbon-nanofibres, but there may also be carbon black particles present at other parts of the network. The carbon black particles preferably have a diameter of at least 0.5 times the diameter of the carbon-nanofibres, more preferably at least the same diameter of the carbon-nanofibres, even more preferably at least 2 times the diameter of the carbon-nanofibres, even more preferably at least 3 times the diameter of the carbon-nanofibres, still more preferably at least 4 times the diameter of the carbon-nanofibres and most preferably at least 5 times the diameter of the carbon-nanofibres. It is preferred that the diameter of the carbon black particles is at most 10 times the diameter of the carbon-nanofibres. Such mixed networks are denoted as hybrid networks.

The porous, chemically interconnected, carbon-nanofibre-comprising carbon networks have a functionalized surface. In other words, the surface comprises groups that alter the hydrophobic nature of the surface—which is typical for carbon—to a more hydrophilic nature. The surface of the carbon networks comprises carboxylic groups, hydroxylic groups and phenolics. These groups add some polarity to the surface and may change the properties of the compound material in which the functionalized carbon networks are embedded. Without wishing to be bound to a theory, it is believed that the functionalized groups bind to the elastomer, for instance by forming H-bonds, and therefore increase the resilience of the materials. Hence at least the stiffness and the durability of the material are altered which may result in lower rolling resistance and increased operational life span of the reinforced elastomer, in particular of tires or conveyor belts comprising said reinforced elastomer.

The porous, chemically interconnected, carbon-nanofibre-comprising carbon networks may comprise metal catalyst nanoparticles. These are a fingerprint of the preparation method. These particles may have an average particle size between 1 nm and 100 nm. Preferably said particles are monodisperse particles having deviations from their average particle size which are within 10%, more preferably within 5%. Non-limiting examples of nanoparticles included in the carbon-nanofibre-comprising carbon networks are the noble metals (Pt, Pd, Au, Ag), iron-family elements (Fe, Co and Ni), Ru, and Cu. Suitable metal complexes may be (i) platinum precursors such as H₂PtCl₆; H₂PtCl₆·xH₂O; K₂PtCl₄; K₂PtCl₄·xH₂O; Pt(NH₃)₄(NO₃)₂; Pt(C₅H₇O₂)₂, (ii) ruthenium precursors such as Ru(NO)(NO₃)₃; Ru(dip)₃Cl₂ [dip=4,7-diphenyl-1,10-fenanthroline]; RuCl₃, or (iii) palladium precursors such as Pd(NO₃)₂, or (iv) nickel precursors such as NiCl₂ or NiCl₂·xH₂O; Ni(NO₃)₂; Ni(NO₃)₂·xH₂O; Ni(CH₃COO)₂; Ni(CH₃COO)₂·xH₂O; Ni(AOT)₂ [AOT=bis(2-ethylhexyl)sulphosuccinate], wherein x may be any integer chosen from 1, 2, 3, 4, 5, 6, 7, 8, 9 or 10 and typically may be 6, 7 or 8.

While the use of these sustainable porous networks is unlimited, the invention particularly pertains to the use of these networks in composites, and to a sustainable composite comprising carbon structure networks according to the invention, further comprising one or more polymers, the networks added for mechanical strength, electrical conductivity or thermal conductivity to said polymer-based composite. The networks may be added in any amount adapted to the desired performance, e.g. 1-70 wt %, more preferably 10-50 wt %, even more preferably between 20-40 wt %, based on the total polymer weight in the composite. In one aspect, the composite shows a network concentration-dependent elasticity modulus (E-modulus, i.e. an increase with increasing concentration of networks) for instance as measured according to ISO 527.

### EXAMPLES

### Example 1. Preparation of Crystalline Carbon Structure Network

Pyrolysis oil o/w micro-emulsions were made in the process according to the invention from:
a) Tire Pyrolysis oil (TPO) obtained from Scandinavian Enviro systems, with carbon content 86-85 wt %, sulfur content 0.7-0.9 wt % and water content 9-13 wt %.
b) Water phase containing iron chloride as catalyst.
c) Surfactant: polyethylene oxide-based surfactant with aromatic hydrophobic group

The appearance of elongated structures observed with SEM was analyzed for different compositions of the micro-emulsions. The cases when elongated structures were observed were:

| Pyrolysis Oil | Surfactant | Added water | Catalyst |
|---|---|---|---|
| 79% | 16% | 6% | 0.73% |
| 74% | 20% | 6% | 0.83% |
| 72% | 20% | 8% | 0.96% |
| 72% | 20% | 8% | 1.12% |
| 70% | 20% | 10% | 1.38% |
| 70% | 20% | 10% | 1.17% |

By injecting the pyrolysis oil emulsions previously described in the process according to the invention, crystalline carbon structure network can be produced. For this example, the furnace reactor used was a Carcass N550 reactor operated at a residence time of 294 ms, temperatures between 1200 and 2000 degrees Celsius and with a feedstock production rate of 3.65 tonnes per hour. The characteristics of this network, obtained via this process, are the following:

| | | | | Standard and/or |
|---|---|---|---|---|
| Characteristics | | Values | Unit | analytical technique |
| IAN | | 40-55 | mg/g | ASTM D1510 |
| OAN | | 70-85 | cc/100 g | ASTM D2414 |
| N₂SA | | 38-53 | m²/g | ASTM D6556 |
| STSA | | 38-53 | m²/g | ASTM D6556 |
| Fibers | | | | |
| | Diameter | 60-75 | nm | SEM |
| | Length | 120-375 | nm | SEM |
| | Aspect ratio | 2-5 | | SEM |
| | Number of | 1-10 | | SEM |
| | junctions | | | |

| Agglomerate size (D50) | 1-15 | μm | Laser diffraction |
|---|---|---|---|
| | | | ISO 13320-1: 2009 |
| pH | 5.3-6.8 | | Internal standard |

This lower pH obtained for the product according to the process is believed to improve the filler interaction with the matrix for carbon made from pyrolysis oil, by improving the interaction with the surface active groups at the surface of these networks, thus making it an improved filler over carbon from anthracene oil.

### Example 2. pH of Carbon from Different Oils

Three batches of carbon networks have been synthesized using three emulsions, each containing a polyethylene oxide-based surfactant with aromatic hydrophobic groups (70% wt), water (10% wt) and FeCl3 (<1% wt), but with the oil component being the variable:
Composition 1: Antracene oil;
Composition 2: Tyre pyrolisis oil (Scandinavian Enviro systems); and
Composition 3: Bio pyrolisis oil (obtained from BTG).

30 milligram of the produced networks powder was grinded and the grinded powder was mixed with demi-water and 2 drops of acetone. The mixture was sonicated for 1 min before the pH was measured.

The resulting pH was 7.7, 7.3 and 6.8, respectively.

The surface of the pyrolysis oil-based carbon networks of compositions 2 and 3 contained carboxylic, hydroxyl and/or epoxy groups. These polar groups increased the affinity of such structures in polar polymers (i.d. epoxy resins, polyamides and polysters, SSBR functionalized for silica) and acidic reactive molecules (maleic anhydride grafted polypropylene of polyethylene, silanes and amino-silanes).

1. A process for the production of crystalline carbon nanofibre networks from pyrolysis oil in a reactor which contains a reaction zone and a termination zone, by injecting a single-phase emulsion, being a micro-emulsion comprising pyrolysis oil and metal catalyst nanoparticles into the reaction zone which is at a temperature of above 600° C., preferably above 700° C., more preferably above 900° C., even more preferably above 1000° C., more preferably above 1100° C., preferably up to 3000° C., more preferably up to 2500° C., most preferably up to 2000° C., to produce crystalline carbon nanofibre networks, transferring these networks to the termination zone, and quenching or stopping the formation of crystalline carbon nanofibre networks in the termination zone by spraying in water.

2. The process according to claim 1, said reactor being a furnace carbon black reactor which contains, along the axis of the reactor, a combustion zone, a reaction zone and a termination zone, by producing a stream of hot waste gas the combustion zone by burning a fuel in an oxygen-containing gas and passing the waste gas from the combustion zone into the reaction zone, spraying a micro-emulsion comprising pyrolysis oil and metal catalyst nanoparticles, in the reaction zone containing the hot waste gas, carbonizing said micro-emulsion at a temperature of above 600° C., preferably above 700° C., more preferably above 900° C., even more preferably above 1000° C., more preferably above 1100° C., preferably up to 3000° C., more preferably up to 2500° C., most preferably up to 2000° C., and quenching or stopping the reaction in the termination zone by spraying in water, to yield crystalline carbon nanofibre networks.

3. The process according to claim 1, wherein the pyrolysis oil phase in the emulsion has a carbon content of at least 40 wt %, and added water content up to 50 wt %, a sulphur content up to 4 wt % and up to 50 wt % of oxygen atom content, based on the total weight of the pyrolysis oil.

4. The process according to claim 1, said emulsion comprising at least 1 mM metal catalyst nanoparticles, preferably having an average particle size between 1 and 100 nm.

5. The process according to claim 1, wherein at least 50 wt %, preferably all of the carbon feedstock from which the networks are made is provided as pyrolysis oil in the single-phase emulsion.

6. The process according to claim 1, wherein the reactor residence time of the pyrolysis oil that is provided in the single phase emulsion is less than 5 seconds, preferably less than 2 seconds, more preferably 1-1000 milliseconds, most preferably 10-500 milliseconds.

7. The process according to claim 1, wherein the pyrolysis oil provided to reactor has a sulphur content between 0.5 and 4.0 wt %, based on the weight of the pyrolysis oil.

8. The process according to claim 1, wherein the pyrolysis oil provided to reactor has an oxygen atom content between 10 and 50 wt % based on the weight of the pyrolysis oil.

9. A sustainable porous carbon network material which comprises chemically interconnected carbon-nanofibres obtainable by the process according to claim 1, wherein the pores in the network have an intraparticle pore diameter size of 5-150 nm using Mercury Intrusion Porosimetiy according to ASTM D4404-10, wherein at least 20 wt % of the carbon in the carbon networks is in crystalline form, and the carbon nanofibers have an average aspect ratio of fibre length-to-thickness of at least 2, wherein the pH of the carbon network obtained is at most 7.5, preferably between 4 and 7.5, most preferably between 5.5 and 7.5, and wherein the carbon is provided by pyrolysis oil.

10. (canceled)

11. A sustainable product, preferably a sustainable plastic or tire product, comprising the sustainable porous carbon networks according to claim 9.

12. A process for producing sustainable crystalline carbon nanofiber networks comprising:
providing a single-phase emulsion of emulsified pyrolysis oil,
carbonizing the emulsion in a carbon black manufacture process, and
obtaining sustainable porous, chemically interconnected, carbon nanofiber-comprising carbon structure networks.

13. The process according to claim 12, wherein the carbon black manufacture process is a furnace carbon black manufacture process.
